(19) United States
(12) Patent Application Publication
(10) Pub. No.: US 2020/0242142 A1
(43) Pub. Date: Jul. 30, 2020

(54) INTELLIGENT CRYPTIC QUERY-RESPONSE IN ACTION PROPOSAL COMMUNICATIONS

(71) Applicant: International Business Machines Corporation, Armonk, NY (US)

(72) Inventors: Jonathan Hudson Connell, II, Cortland-Manor, NY (US); Sharathchandra Pankanti, Fairfield County, CT (US)

(73) Assignee: International Business Machines Corporation, Armonk, NY (US)

(21) Appl. No.: 16/256,663

(22) Filed: Jan. 24, 2019

(51) Int. Cl. G06F 16/332; G06F 17/27; G06F 16/34; G06F 16/33; G06N 3/08

(52) U.S. Cl. CPC G06F 16/3329; G06F 17/274; G06N 3/08; G06F 16/3347; G06F 16/345

(57) ABSTRACT

A textual message that is nonconforming to a grammar of a language is received. The textual message is transformed into a grammatically structured interrogative form. A first sentence of a received content is scored relative to the interrogative form. The received content includes a proposal for an action in a form of a plurality of grammatically compliant structures. Based on the scoring, a response sentence having a highest score is selected. Responsive to the highest score corresponding to the response sentence being above a threshold, the response sentence is transformed into a corresponding summary phrase that is not constrained by the grammar.

### TECHNICAL FIELD

The present invention relates generally to a method, system, and computer program product for analyzing natural language content. More particularly, the present invention relates to a method, system, and computer program product for intelligent cryptic query-response in action proposal communications.

### BACKGROUND

When creating a document proposing an action, users have varying communication styles. One user might prefer to assemble one document, including answers to all anticipated questions, and provide a complete document for another to use. Another user might prefer to communicate only the bare proposal, then answer any follow-up questions as questions occur.

Users also have varying communication styles for consuming a document proposing an action. One user might prefer to receive one complete document, without the need to follow up for additional information. Another user might feel overwhelmed by a large document including information perceived as unneeded, and prefer a short summary and short answers to any necessary follow-up queries.

As well, there are often mismatches between a writer's and a reader's communication styles. A writer may perceive a document as of an appropriate length and completeness, while a reader may perceive the same document as either overly verbose and including unnecessary information or overly terse and lacking necessary detail.

Different communication styles are not the only issue. Prevailing methods of communication, e.g., texting, forego grammatical or linguistic correctness in the interest of getting the essence of an idea across. In such communications, incomplete sentences, incorrect grammar, incorrect spellings, alphanumeric phrases, intermixed graphics, and other such variations are common and used with the central thrust behind communicating an idea—the essence of the message—without the restrictions of a natural language.

Further, even a user who normally communicates in complete, grammatically correct sentences or prefers to consume an entire document at once may be in a situation where this is impractical or ill-advised. For example, this user may only have a small display screen available on which to read the document, may have a visual impairment making reading text difficult, or may be performing another activity (e.g., driving) during which the user should not also be reading text.

### SUMMARY

The illustrative embodiments provide a method, system, and computer program product. An embodiment includes a method that receives a textual message, wherein the textual message is nonconforming to a grammar of a language. An embodiment transforms the textual message into a grammatically structured interrogative form. An embodiment scores, relative to the interrogative form, a first sentence of a received content, wherein the received content comprises a proposal for an action in a form of a plurality of grammatically compliant structures. An embodiment selects, based on the scoring, a response sentence having a highest score. An embodiment transforms, responsive to the highest score corresponding to the response sentence being above a threshold, the response sentence into a corresponding summary phrase, wherein the summary phrase is not constrained by the grammar.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for intelligent cryptic query-response in action proposal communications in accordance with an illustrative embodiment;

FIG. 4 depicts a block diagram of more detail of an example configuration for intelligent cryptic query-response in action proposal communications in accordance with an illustrative embodiment;

FIG. 5 depicts examples of stages in intelligent cryptic query-response in action proposal communications in accordance with an illustrative embodiment;

FIG. 6 depicts a flowchart of an example process for intelligent cryptic query-response in action proposal communications in accordance with an illustrative embodiment;

FIG. 7 depicts another flowchart of an example process for intelligent cryptic query-response in action proposal communications in accordance with an illustrative embodiment;

FIG. 8 depicts another flowchart of an example process for intelligent cryptic query-response in action proposal communications in accordance with an illustrative embodiment; and

FIG. 9 depicts another flowchart of an example process for intelligent cryptic query-response in action proposal communications in accordance with an illustrative embodiment; and

FIG. 10 depicts another flowchart of an example process for intelligent cryptic query-response in action proposal communications in accordance with an illustrative embodiment.

### DETAILED DESCRIPTION

As used herein, a document creator is any source of a natural language document, including both a human user and an automated system that prepare such document for consumption. A document consumer is a human user who perceives a portion of the content of the document in any usable form, including by reading at least a portion of the text, hearing a version of at least a portion of the text converted to aural form, and reading or hearing a portion of the text in translated, summarized, or rearranged form.

As used herein, an action proposal communication refers to a document proposing an action.

The illustrative embodiments recognize that mismatches in communication styles and preferences between document creators and document consumers cause both parties to have difficulty working together, as well as wasting time and, consequently, money. A document consumer who receives a document he or she perceives as verbose may not want to take the time to find the precise information needed, may miss key information within the document, or may simply ignore the document as involving too much reading time. Conversely, a document consumer who receives a terse document requiring follow-up queries and responses may delay a decision on the proposed action until all the queries have been answered and perceive the necessity for follow-ups as inefficient—or may simply ignore the document as incomplete or insufficiently thought out. Such mismatches may also cause both parties to be frustrated or annoyed with each other for not having the document in the “correct” format, where each party perceives correctness differently.

The illustrative embodiments also recognize that an unmet need exists to recognize cryptic messages from the consumer and interpret them as questions pertaining to the content. An unmet need exists to not only extract reasonable answers for the questions from the content but also to deliver them in a compact or cryptic manner recognizable by the consumer

The illustrative embodiments recognize that the presently available tools or solutions do not address these problems or needs or provide adequate solutions for these problems or needs. The illustrative embodiments used to describe the invention generally address and solve the above-described problems and other problems related to intelligent cryptic query-response in action proposal communications.

An embodiment can be implemented as a software application. The application implementing an embodiment can be configured as a modification of an existing document communication system or document management system, as a separate application that operates in conjunction with an existing document communication system or document management system, a standalone application, or some combination thereof.

Particularly, some illustrative embodiments provide a method by which natural language content proposing an action is transformed into a summary response in response to an abbreviated query. Neither the summary response nor the query are necessarily in a grammatically structured form. As used herein, a query that is not necessarily in a grammatically structured form is also referred to as a cryptic query, and a summary response that is not necessarily in a grammatically structured form is also referred to as a cryptic response. Together, a cryptic query and a cryptic response to a cryptic query are referred to as a cryptic query-response.

An embodiment receives content in the form of a document, written in natural language, to be transformed. The document is a proposal for an action in the form of grammatically compliant structures such as sentences. The document may be in any text format and in any language the embodiment is capable of processing.

An embodiment also receives a query, also in natural language textual form, about the document. If the query is not initially received in text form, the query is converted to text form. For example, the query may be in aural form. The query is not necessarily in a grammatically structured interrogative form. This is especially likely if a user generating the query was using a limited user interface, such as a text messaging platform, or spoke the query instead of typing. For example, the query “Why do we need these?” is a complete sentence according to the rules of English grammar, but the queries, “Reasons?” and “Why?” lack a subject and an object and thus are not complete sentences according to the rules of English grammar. When the query is not in a grammatically structured interrogative form, an embodiment transforms the query into a corresponding grammatically structured interrogative form.

An embodiment groups portions of the content into one or more topics. Some documents include more than one proposal for an action, or include content that is not relevant to an included proposal for an action. When a document includes multiple proposals, the received query should be answered with respect to each proposal, unless the query only relates to one of the proposals. When a document includes a proposal and additional unrelated content, the received query should be answered with respect to the proposal and not the unrelated content.

An embodiment identifies individual sentences within the document, and identifies individual words within sentences. Words and sentences are identifiable using rules of grammar. For example, a correctly-formed English sentence ends with a period or other punctuation mark, followed by a space or other section delineation such as a new paragraph. The words of incorrectly-formed English sentences, such as run-on sentences or sentence fragments, are placed into appropriate sentences or word groupings processed as sentences using known grammar rules. For example, given the run-on sentence, “I took my dog to the park he liked it,” “he” denotes the start of a new sentence even without the missing period. English words are separated by spaces, other white space, or other punctuation.

English is used as a non-limiting example of a natural language of the content. From this disclosure, those of ordinary skill in the art will be able to adapt an embodiment to operate in a described manner with content in other languages, and such adaptations are contemplated within the scope of the illustrative embodiments.

An embodiment scores sentences within a topic of the received document relative to the transformed query. A score reflects how well the sentence correlates with query—or, in other words, how well the sentence answers the query. Typically, a score is on a 0-1 scale, with 0 meaning no correlation and 1 meaning perfect correlation, but other scoring schemes are also possible and contemplated within the scope of the embodiments.

One embodiment performs scoring using classical techniques such as part of speech analysis. An embodiment classifies the query into a type. One classification scheme uses seven query types: summary, who, what, when, where, how, and why. Other classification schemes, with more or fewer categories, are also possible. One embodiment assigns a part of speech tag to identified words in both the query and a sentence to be scored. A part of speech tag identifies a part of speech for a word according to rules of grammar for a language. For example, in English, “dog” is a singular noun, “dogs” is a plural noun, and “walked” is a verb in the past tense. A word may be associated with more than one type. For example, “walk” is both a singular noun and a verb in the present tense.

To classify a query into a query type, an embodiment consults a table scoring how well each identified word or tag type correlates with a particular query classification, then combines each word score into an overall query score. For example, if a query includes the word “why”, it is likely a query of type why, not a query of type how. To score a content sentence based on how well the sentence answers the query, an embodiment consults a table of how well each identified word or tag type correlates to other sentences answering that particular query type, then combines each word score into an overall sentence score. For example, a combination of the word “should” with an active transitive verb (a transitive verb takes an object—e.g. “buy [something]”) will likely score high as a summary sentence. As another example, a sentence containing “because” will likely score high as an answer to a why query. Each table can be generated from hand labeled examples, either in a probabilistic framework or using a statistical classifier such as a deep neural network.

Another embodiment performs scoring using a neural network. One embodiment utilizes an n-way classifier—a neural network trained to classify an input sentence into n query types based on how well the input sentence answers each of the query types. For example, if two of the n query types are why and how, and the classifier produces a score of 0.9 at the why output and 0.3 at the how output, the input sentence likely responds to a why query and not a how query. One embodiment uses a bag of words approach, and does not take word order or word importance within a sentence into account. Another embodiment utilizes a Long Short Term Memory (LSTM) that does take word order into account.

Another embodiment performs scoring using a combination of part of speech analysis and neural network analysis, on both the query and the content. One embodiment uses part of speech analysis to classify the query into a query type, then scores sentences using a neural network trained to identify sentences that correlate to that particular query type. Another embodiment scores input sentences using both part of speech analysis and a neural network approach, then uses both sentence scores to compute a final sentence score. One embodiment averages both sentence scores to obtain the final score, while another embodiment uses a voting scheme comparing both results to obtain the final score. As well, other sentence scoring schemes, using other combinations of classical, neural network, and other techniques, are also contemplated within the scope of the illustrated embodiments.

An embodiment selects the sentence having the highest score that is also above a threshold score. This is the sentence that best correlates with the query—or, in other words, the sentence that best answers the query—that is also sufficiently high scored to be a credible result.

An embodiment transforms the selected sentence into a summary response phrase. A summary phrase answers the query, but is not necessarily a complete sentence or otherwise compliant with grammar rules of a language. Thus, a summary phrase is also not constrained by the grammar rules.

To transform the selected sentence, an embodiment removes extraneous words and clauses. For example, in the sentence, “I think maybe we should buy computers,” “I think maybe” is extraneous and can be removed. One embodiment identifies one or more clauses within a sentence that are likely to be extraneous, and removes those clauses. Another embodiment uses a neural network to determine how important each word in a sentence is to the overall meaning of the sentence, then removes each word with an importance below a threshold importance. Another embodiment uses a neural network to identify boundaries of a phrase within a sentence, then uses classical heuristics to determine whether the phrase is extraneous and can be removed. Other techniques and combinations of techniques are also possible and contemplated within the scope of the illustrative embodiments.

To transform the selected sentence, an embodiment also resolves any unresolved references within the sentence. Unresolved references are references that refer to data elsewhere in the document. For example, in the sentence, “They need them to run the latest version of the database software,” “they” and “them” refer to entities that are defined elsewhere in the document. When read in context, a reader will understand the references. However, when taken out of context, the references are unresolved and must be replaced by the objects of the references to ensure comprehension. Hence, an appropriate substitution in this example might be, “The office assistants need the new computers to run the latest version of the database software.”

An embodiment can be configured to generate a summary response phrase that is compact, without regard to grammatical correctness or preservation of linguistic structures and rules. For example, the summary phrase “The office assistants need the new computers to run the latest version of the database software,” might be further reduced to “to run the latest version of the database software” or even “to run the latest software” or “run latest”. The spelling of words might also be abbreviated. For example, “for you” could be changed into “4 u”.

An embodiment presents a summary phrase to a document consumer using any method for which the consumer is equipped. One embodiment displays the summary phrase on a display screen. Another embodiment presents the summary phrase in aural form.

An embodiment includes an ability to respond to a follow-up query in a manner described herein. A query is classified as a follow-up query, and a responsive summary phrase prepared and presented. If the follow-up query indicates that a previous responsive summary was unacceptable to the user (for example, the user responds, “Huh?”) an embodiment responds with a different phrase, such as a phrase derived from the second most highly scored sentence.

An embodiment runs the process in reverse, generating a natural language proposal for an action from a series of answers to generated queries.

The manner of intelligent cryptic query-response in action proposal communications described herein is unavailable in the presently available methods in the technological field of endeavor pertaining to electronic document communication systems. A method of an embodiment described herein, when implemented to execute on a device or data processing system, comprises substantial advancement of the functionality of that device or data processing system in producing a summary response phrase in response to an abbreviated query on natural language content.

The illustrative embodiments are described with respect to certain types of contents, queries, query types, abbreviated queries, parts of speech, tags, sentences, clauses, scores, thresholds, response phrases, summary phrases, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

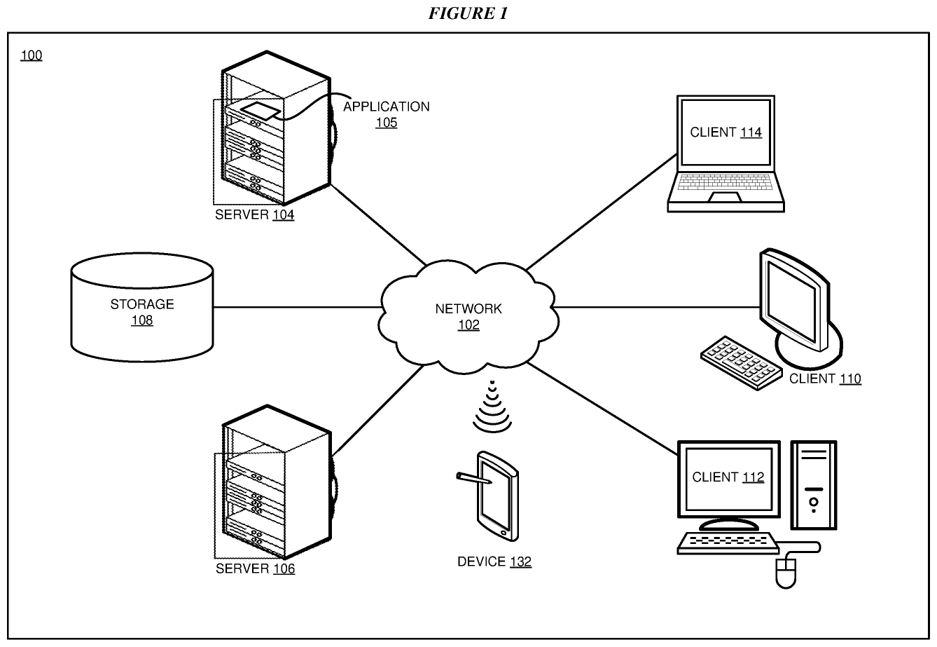

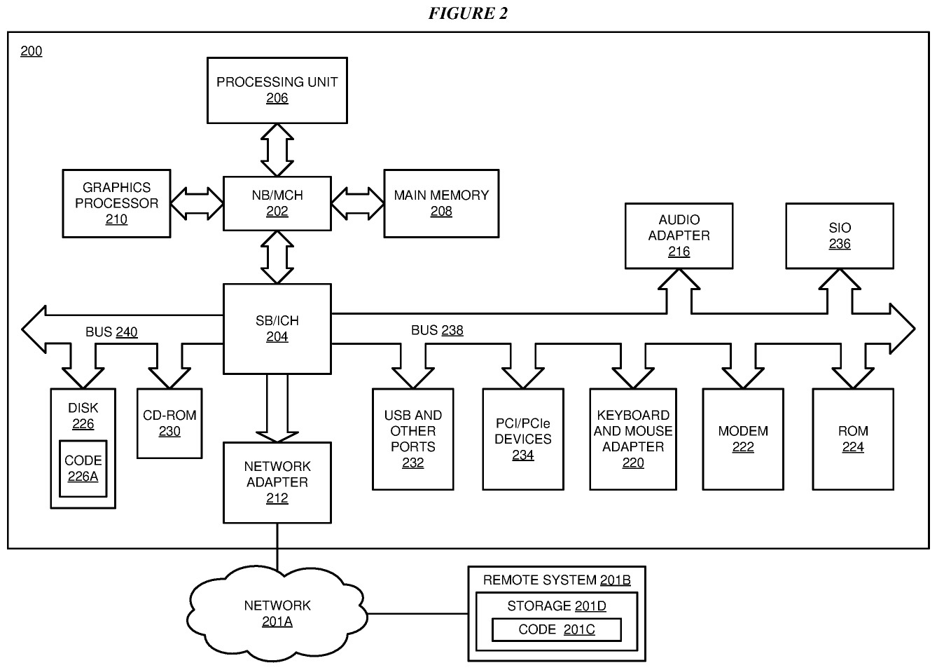

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 receives a document and a query, for example over network 102, and produces a summary response phrase. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. In another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

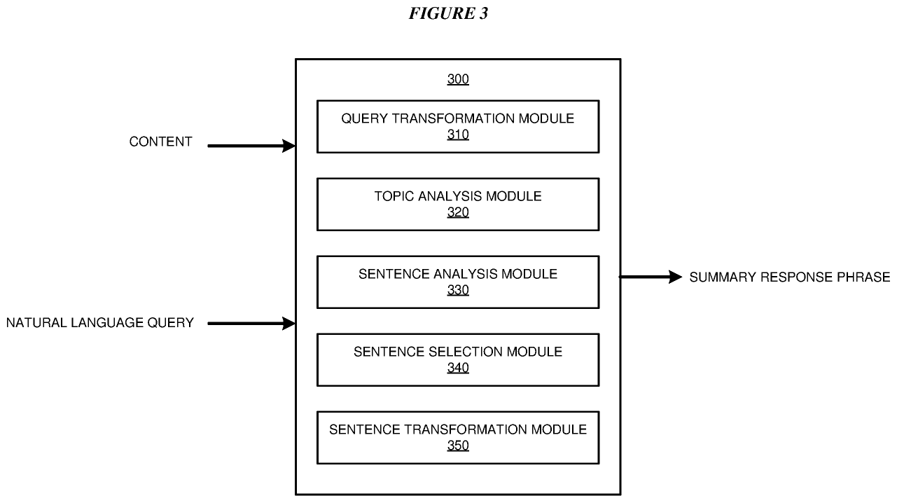

With reference to FIG. 3, this figure depicts a block diagram of an example configuration for intelligent cryptic query-response in action proposal communications in accordance with an illustrative embodiment. Application 300 is an example of application 105 in FIG. 1 and executes in any of servers 104 and 106, clients 110, 112, and 114, and device 132 in FIG. 1.

Application 300 receives content in the form of a document, written in natural language, to be transformed. The document is a proposal for an action in the form of grammatically compliant structures. Application 300 also receives a query, in natural language textual form, about the document. Query transformation module 310 analyzes the query and transforms the query, if necessary, into a corresponding grammatically structured interrogative form. Topic analysis module 320 groups portions of the content into one or more topics.

Sentence analysis module 330 scores sentences within a topic of the received document relative to the transformed query. A score reflects how well the sentence correlates with query—or, in other words, how well the sentence answers the query. Sentence analysis module 330 classifies the query into one of seven query types: summary, who, what, when, where, how, and why. One version of sentence analysis module 330 uses classical techniques such as part of speech analysis. Another version of sentence analysis module 330 uses a neural network. Another version of sentence analysis module 330 uses a combination of part of speech analysis and neural network analysis, on both the query and the content.

Sentence selection module 340 selects the sentence having the highest score that is also above a threshold score. This is the sentence that best correlates with the query—or, in other words, the sentence that best answers the query—that is also sufficiently high scored to be a credible result.

Sentence transformation module 350 transforms the selected sentence into a summary phrase. Application 300 then outputs the summary phrase.

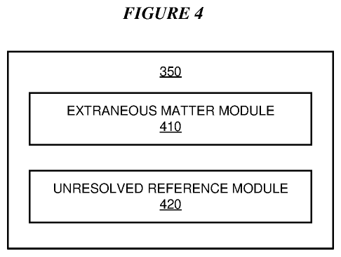

With reference to FIG. 4, this figure depicts a block diagram of more detail of an example configuration for intelligent cryptic query-response in action proposal communications in accordance with an illustrative embodiment. In particular, FIG. 4 depicts more detail of sentence transformation module 350 in FIG. 3.

Extraneous matter module 410 removes extraneous words and clauses form the response sentence. One version of module 410 identifies one or more clauses within a sentence that are likely to be extraneous, and removes those clauses. Another version of module 410 uses a neural network to determine how important each word in a sentence is to the overall meaning of the sentence, then removes each word with an importance below a threshold importance. A third version of module 410 uses a neural network to identify boundaries of a phrase within a sentence, then uses classical heuristics to determine whether the phrase is extraneous and can be removed. Unresolved reference module 420 resolves any unresolved references within the sentence, using data elsewhere in the document.

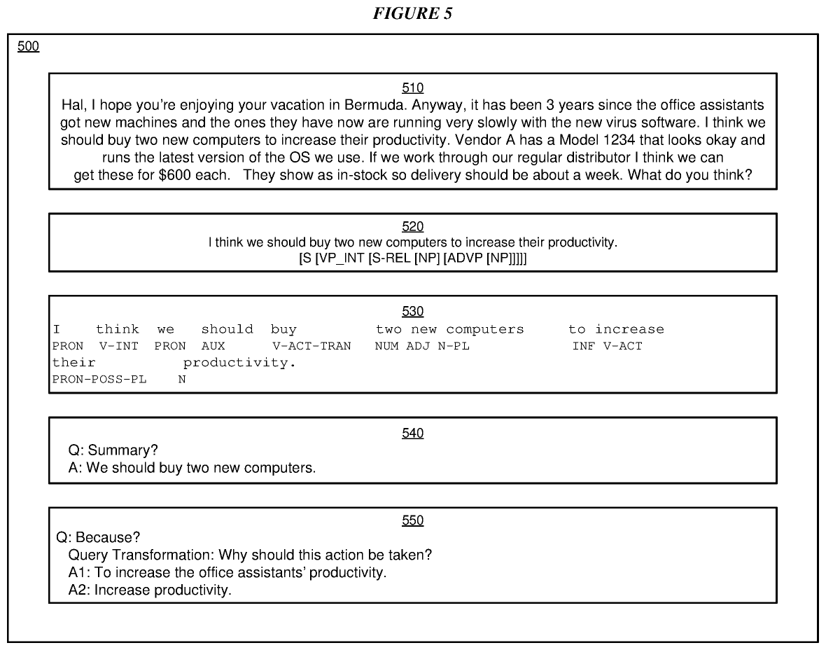

With reference to FIG. 5, this figure depicts examples of stages in intelligent cryptic query-response in action proposal communications in accordance with an illustrative embodiment. The examples in FIG. 5 are produced by application 300 in FIG. 3.

Example 510 depicts example content in the form of a document, written in natural language, to be transformed. Here, the example document is in the form of an email from an employee to his or her manager who is out of the office, and reads, “Hal, I hope you're enjoying your vacation in Bermuda. Anyway, it has been 3 years since the office assistants got new machines and the ones they have now are running very slowly with the new virus software. I think we should buy two new computers to increase their productivity. Vendor A has a Model 1234 that looks okay and runs the latest version of the OS we use. If we work through our regular distributor I think we can get these for $600 each. They show as in-stock so delivery should be about a week. What do you think?”

Example 520 depicts division of a sentence from the content in example 510 into a hierarchy of labelled sentences and clauses delineated by square brackets. Here, the top level of the hierarchy for this particular sentence is S, which denotes a complete sentence. At the next level down, VP_INT denotes an intent. Because VP_INT is the only tag at this level, the entire sentence represents an intent (“I think we should buy two new computers to increase their productivity.”) At the next level down, S-REL denotes a sentence relative clause, i.e. a component constituted as a sentence but relative to another sentence. Here, the entire sentence has been tagged in this manner because “their productivity” refers to persons (the office assistants) identified elsewhere in the document. At the next level down, there are two tags. [NP] denotes a noun phrase. [ADVP [NP]] denotes an adverb phrase including another noun phrase.

Example 530 depicts the same sentence from the content in example 510, with each word assigned a part of speech tag according to rules of English grammar. Here, “I” is tagged with PRON denoting a pronoun. “think” is tagged with V-INT denoting an intent verb. “we” is also tagged with PRON denoting a pronoun. “should” is tagged with AUX denoting an auxiliary verb. “buy” is tagged with V-ACT-TRAN denoting an active transitive verb. “two” is tagged with NUM denoting a number. “new” is tagged with ADJ denoting an adjective. “computers” is tagged with N-PL denoting a plural noun. “to” is tagged with INF denoting an infinitive marker. “increase” is tagged with V-ACT denoting an active verb. “their” is tagged with PRON-POSS-PL denoting a possessive pronoun. And “productivity” is tagged with N denoting a noun.

Example 540 depicts an abbreviated query (“Summary?”) with respect to the content of example 510. Example 540 also depicts an example summary phrase in response to the query: “We should buy two new computers.” To produce this result, application 300 scored the sentence “I think we should buy two new computers to increase their productivity” as the best correlated with answering a query for a summary, then removed “I think” and “to increase their productivity” as extraneous.

Example 550 depicts a different abbreviated query (“Because?”) with respect to the content of example 510. Here, application 300 transforms the abbreviated query into a grammatically conforming query “Why should this action be taken?” Application 300 scores sentences within the content of example 510, determines that the sentence “I think we should buy two new computers to increase their productivity” as the best correlated with answering a why query, and removes extraneous material to produce the summary phrase, “to increase the office assistants' productivity.” Alternatively, application 300 reduces the summary phrase even further, to “increase productivity”.

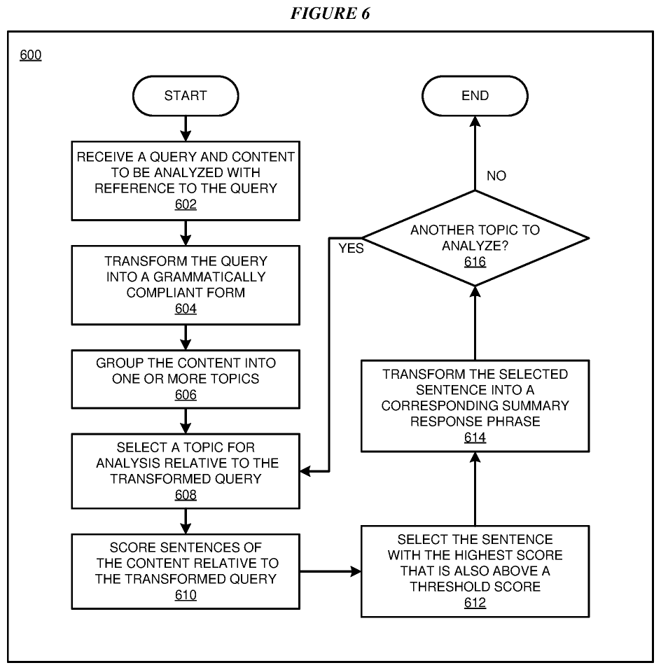

With reference to FIG. 6, this figure depicts a flowchart of an example process for intelligent cryptic query-response in action proposal communications in accordance with an illustrative embodiment. Process 600 can be implemented in application 300 in FIG. 3.

In block 602, the application receives a query and content to be analyzed with reference to the query. In block 604, the application transforms the query into a grammatically compliant form. In block 606, the application groups the content into one or more topics. In block 608, the application selects a topic for analysis relative to the transformed query. In block 610, the application scores one or more sentences of the content relative to the transformed query. In block 612, the application selects the sentence with the highest score, where the score is also above a threshold score. In block 614, the application transforms the selected sentence into a corresponding summary phrase. In block 616, the application checks whether there is another topic within the content to analyze. If so (“YES” path of block 616), the application returns to block 608 to select another topic. If not (“NO” path of block 616), the application ends.

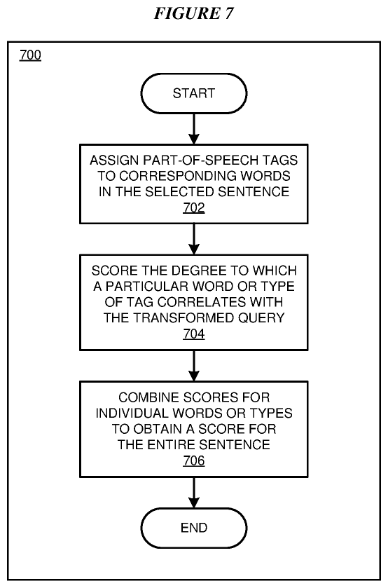

With reference to FIG. 7, this figure depicts another flowchart of an example process for intelligent cryptic query-response in action proposal communications in accordance with an illustrative embodiment. Process 700 depicts more detail of block 610 in FIG. 6.

In block 702, the application assigns part-of-speech tags to corresponding words in the selected sentence. In block 704, the application scores the degree to which a particular word or type of tag correlates with the transformed query. In block 706, the application combines scores for individual words or types of tags to obtain a score for the entire sentence. Then the application ends.

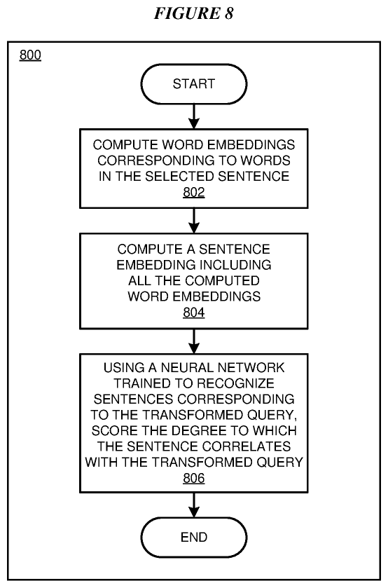

With reference to FIG. 8, this figure depicts another flowchart of an example process for intelligent cryptic query-response in action proposal communications in accordance with an illustrative embodiment. Process 800 depicts more detail of block 610 in FIG. 6.

In block 802, the application computes word embeddings corresponding to words in the selected sentence. In block 804, the application computes a sentence embedding including all the computed word embeddings. In block 806, the application uses a neural network trained to recognize sentences corresponding to the transformed query to score the degree to which a particular sentence correlates with the transformed query. Then the application ends.

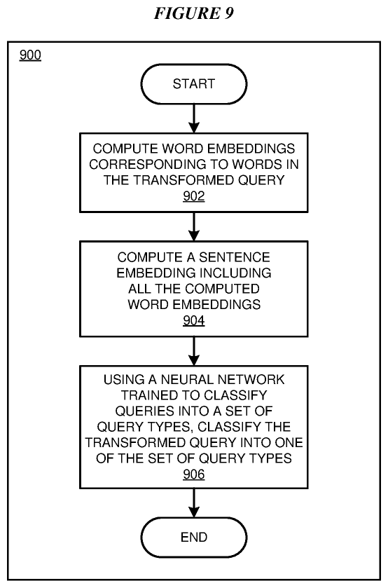

With reference to FIG. 9, this figure depicts another flowchart of an example process for intelligent cryptic query-response in action proposal communications in accordance with an illustrative embodiment. Process 900 depicts more detail of block 610 in FIG. 6.

In block 902, the application computes word embeddings corresponding to words in the selected sentence. In block 904, the application computes a sentence embedding including all the computed word embeddings. In block 906, the application uses a neural network trained to classify queries into a set of query types to classify the transformed query into one of the set of query types. Then the application ends.

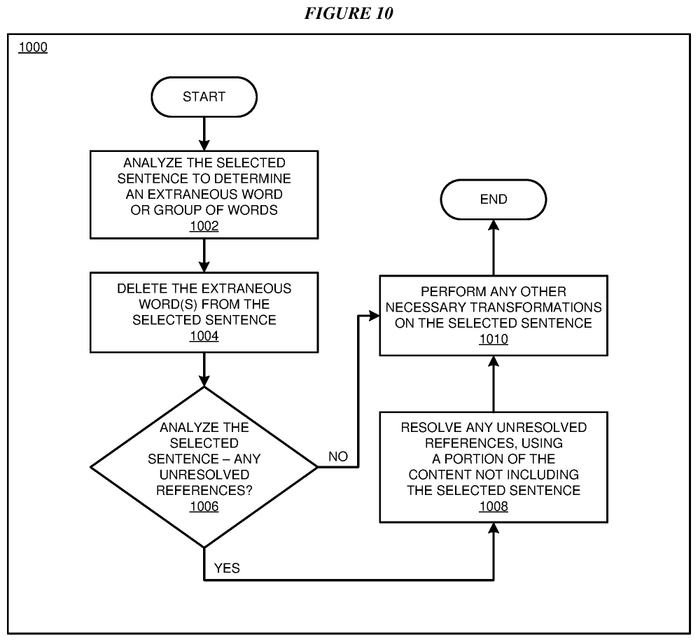

With reference to FIG. 10, this figure depicts another flowchart of an example process for intelligent cryptic query-response in action proposal communications in accordance with an illustrative embodiment. Process 1000 depicts more detail of block 614 in FIG. 6.

In block 1002, the application analyzes the selected sentence to determine an extraneous word or group of words. In block 1004, the application deletes the extraneous word or words from the selected sentence. In block 1006, the application analyzes the remainder of the selected sentence to determine if there are any unresolved references. If so (“YES” path of block 1006), in block 1008 the application resolves any unresolved references using a portion of the content that does not include the selected sentence. In any case, in block 1010 the application performs any other necessary transformations on the selected sentence to produce a summary phrase. Then the application ends.

Thus, a computer implemented method, system or apparatus, and computer program product are provided in the illustrative embodiments for intelligent cryptic query-response in action proposal communications and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving a textual message, wherein the textual message is nonconforming to a grammar of a language;
transforming the textual message into a grammatically structured interrogative form;
scoring, relative to the interrogative form, a first sentence of a received content, wherein the received content comprises a proposal for an action in a form of a plurality of grammatically compliant structures;
selecting, based on the scoring, a response sentence having a highest score; and
transforming, responsive to the highest score corresponding to the response sentence being above a threshold, the response sentence into a corresponding summary phrase, wherein the summary phrase is not constrained by the grammar.

2. The method of claim 1, wherein the scoring further comprises:
scoring, relative to the interrogative form and a topic of a portion of the content, a first sentence of the portion of the content.

3. The method of claim 1, wherein the scoring further comprises:
classifying, into a query type, the interrogative form; and
scoring, relative to the query type, the first sentence.

4. The method of claim 1, wherein the scoring further comprises:
assigning, to each word in the first sentence, a tag corresponding to a type of the word;
scoring a degree to which each tagged word correlates with the interrogative form; and
combining, to obtain a sentence score, a score corresponding to each scored word.

5. The method of claim 1, wherein the scoring further comprises:
computing a word embedding corresponding to a word in the first sentence;
computing a sentence embedding comprising each computed word embedding; and
scoring, using a neural network trained to recognize a sentence embedding corresponding to the interrogative form, the sentence embedding.

6. The method of claim 1, wherein transforming the response sentence into a corresponding summary phrase further comprises:
analyzing, to determine an extraneous word, the response sentence;
removing, from the response sentence, the extraneous word;
analyzing, to determine whether a reference is unresolved, the response sentence; and
resolving, responsive to determining an unresolved reference, using a portion of the content not including the response sentence, the unresolved reference.

7. The method of claim 1, wherein the summary phrase is nonconforming to the grammar.

8. A computer usable program product comprising one or more computer-readable storage devices, and program instructions stored on at least one of the one or more storage devices, the stored program instructions comprising:
program instructions to receive a textual message, wherein the textual message is nonconforming to a grammar of a language;
program instructions to transform the textual message into a grammatically structured interrogative form;
program instructions to score, relative to the interrogative form, a first sentence of a received content, wherein the received content comprises a proposal for an action in a form of a plurality of grammatically compliant structures;
program instructions to select, based on the scoring, a response sentence having a highest score; and
program instructions to transform. responsive to the highest score corresponding to the response sentence being above a threshold, the response sentence into a corresponding summary phrase, wherein the summary phrase is not constrained by the grammar.

9. The computer usable program product of claim 8, wherein the scoring further comprises:
program instructions to score, relative to the interrogative form and a topic of a portion of the content, a first sentence of the portion of the content.

10. The computer usable program product of claim 8, wherein the scoring further comprises:
program instructions to classify, into a query type, the interrogative form; and
program instructions to score, relative to the query type, the first sentence.

11. The computer usable program product of claim 8, wherein the scoring further comprises:
program instructions to assign, to each word in the first sentence, a tag corresponding to a type of the word;
program instructions to score a degree to which each tagged word correlates with the interrogative form; and
program instructions to combine, to obtain a sentence score, a score corresponding to each scored word.

12. The computer usable program product of claim 8, wherein the scoring further comprises:
program instructions to compute a word embedding corresponding to a word in the first sentence;
program instructions to compute a sentence embedding comprising each computed word embedding; and
program instructions to score, using a neural network trained to recognize a sentence embedding corresponding to the interrogative form, the sentence embedding.

13. The computer usable program product of claim 8, wherein program instructions to transform the response sentence into a corresponding summary phrase further comprises:
program instructions to analyze, to determine an extraneous word, the response sentence;
program instructions to remove, from the response sentence, the extraneous word;
program instructions to analyze, to determine whether a reference is unresolved, the response sentence; and
program instructions to resolve, responsive to determining an unresolved reference, using a portion of the content not including the response sentence, the unresolved reference.

14. The computer usable program product of claim 8, wherein the summary phrase is nonconforming to the grammar.

15. The computer usable program product of claim 8, wherein the computer usable code is stored in a computer readable storage device in a data processing system, and wherein the computer usable code is transferred over a network from a remote data processing system.

16. The computer usable program product of claim 8, wherein the computer usable code is stored in a computer readable storage device in a server data processing system, and wherein the computer usable code is downloaded over a network to a remote data processing system for use in a computer readable storage device associated with the remote data processing system.

17. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive a textual message, wherein the textual message is nonconforming to a grammar of a language;
program instructions to transform the textual message into a grammatically structured interrogative form;
program instructions to score, relative to the interrogative form, a first sentence of a received content, wherein the received content comprises a proposal for an action in a form of a plurality of grammatically compliant structures;
program instructions to select, based on the scoring, a response sentence having a highest score; and
program instructions to transform. responsive to the highest score corresponding to the response sentence being above a threshold, the response sentence into a corresponding summary phrase, wherein the summary phrase is not constrained by the grammar.

18. The computer system of claim 17, wherein the scoring further comprises:
program instructions to score, relative to the interrogative form and a topic of a portion of the content, a first sentence of the portion of the content.

19. The computer system of claim 17, wherein the scoring further comprises:
program instructions to classify, into a query type, the interrogative form; and
program instructions to score, relative to the query type, the first sentence.

20. The computer system of claim 17, wherein the scoring further comprises:
program instructions to assign, to each word in the first sentence, a tag corresponding to a type of the word;
program instructions to score a degree to which each tagged word correlates with the interrogative form; and
program instructions to combine, to obtain a sentence score, a score corresponding to each scored word.
